(19) United States
(12) Patent Application Publication
(10) Pub. No.: US 2014/0041779 A1
(43) Pub. Date: Feb. 13, 2014

(54) Pneumatic Tire

(71) Applicants: Yoshio Ueda, Hiratsuka-shi (JP); Hiroshi Kakizawa, Hiratsuka-shi (JP)

(72) Inventors: Yoshio Ueda, Hiratsuka-shi (JP); Hiroshi Kakizawa, Hiratsuka-shi (JP)

(73) Assignee: The Yokohama Rubber Co., LTD., Minato-ku, Tokyo (JP)

(21) Appl. No.: 14/111,433

(22) PCT Filed: Apr. 11, 2012
(86) PCT No.: PCT/JP2012/059927

§ 371 Date: Oct. 11, 2013

(30) Foreign Application Priority Data
Apr. 12, 2011 (JP) 2011-088027

(51) Int. Cl. B60C 9/04; B60C 9/00

(52) U.S. Cl. CPC B60C 9/0007; B60C 9/04; B60C 9/2006
USPC 152/451; 152/527; 152/556

(57) ABSTRACT

The pneumatic tire according to the present technology has a reinforcing layer in which a plurality of steel cords is laid in parallel and embedded in rubber, wherein each steel cord is configured from a plurality of wires twisted together, the wire diameter is from 0.15 mm to 0.40 mm, each wire is configured from a core and a plating layer formed on the periphery of the core, the core is made from carbon steel with a carbon content of from 0.60 mass % to 0.75 mass %, the average thickness of the plating layer is from 0.23 μm to 0.33 μm, and the strength of the steel cord is from 3000 MPA to 3500 MPa.

### TECHNICAL FIELD

The present technology relates to a pneumatic tire that includes a reinforcing layer in which a plurality of steel cords is laid in parallel embedded in rubber, and more particularly relates to a pneumatic tire that can exhibit durability performance equal to or greater than the durability performance when steel cord made from carbon steel with carbon content exceeding 0.75 mass % is used, even when steel cord made from carbon steel with a carbon content of not more than 0.75 mass % having excellent productivity is used.

### BACKGROUND

Conventionally, piano wire made from carbon steel with a carbon content in excess of 0.75% is used for the steel cord used in the reinforcing layer of pneumatic tires, in order to obtain high strength (for example, see Japanese Unexamined Patent Application Publication No. H03-193983 and Japanese Unexamined Patent Application Publication No. 2000-178887). However, the wire drawing process for piano wire made from carbon steel with a carbon content exceeding 0.75% is difficult, which has the disadvantage that the productivity of the steel cord is poor.

In contrast, if piano wire made from carbon steel having a carbon content of not more than 0.75%, for which the wire drawing process is easy, is used as the starting material, the productivity of the steel cord can be increased by carrying out the wire drawing process on the wire to obtain the material for the steel cords. However, if steel cord made from carbon steel with a carbon content of not more than 0.75% is used, the durability performance of the pneumatic tire is reduced compared with the case using steel cord made from carbon steel with a carbon content exceeding 0.75 mass %.

### SUMMARY

The present technology provides a pneumatic tire that can exhibit durability performance equal to or greater than the durability performance when steel cord made from carbon steel with a carbon content exceeding 0.75 mass % is used, even when steel cord made from carbon steel with a carbon content of not more than 0.75 mass % is used.

The pneumatic tire according to the present technology to achieve the above object is a pneumatic tire comprising a reinforcing layer formed from a plurality of steel cords being laid in parallel and embedded in rubber, each of the steel cords being configured from a plurality of wires twisted together, a wire diameter of each of the wires being from 0.15 mm to 0.40 mm, each of the wires comprising a core and a plating layer formed on the periphery of the core, the core being made from carbon steel with a carbon content of 0.60 mass % to 0.75 mass %, an average thickness of the plating layer being from 0.23 μm to 0.33 μm, and a strength of the steel cord being from 3,000 MPa to 3,500 MPa.

### BRIEF DESCRIPTION OF THE DRAWINGS

FIG. 1 is a meridian cross-sectional view illustrating a pneumatic tire according to an embodiment of the present technology.

FIG. 2 is a cross-sectional view illustrating a steel cord used in a reinforcing layer in the present technology.

FIG. 3 is a cross-sectional view illustrating an enlargement of a wire of the steel cord in FIG. 2.

### DETAILED DESCRIPTION

The inventors discovered that by obtaining wire for steel cord by using piano wire made from carbon steel with a carbon content of not more than 0.75 mass % as the starting material, by carrying out severe plastic deformation on this wire by wire drawing to a high degree, and increasing the orientation of the steel structure, it was possible to achieve a strength equal to or greater than conventionally used steel cord made from carbon steel with a carbon content exceeding 0.75 mass %. However, when the high strength steel cord was obtained based on severe plastic deformation, irregularities formed on the ferrous substrate of the core increased, so the plating layer formed on the surface of the steel cord was locally thinned, and as a result, sometimes pinholes were formed in the plating layer, and the pinholes caused the adhesion of the steel cord to be reduced. Therefore, in order to avoid the formation of pinholes in the plating layer, the inventors intensively researched the optimum thickness of the plating layer in the steel cord that had been subject to severe plastic deformation, and arrived at the present technology.

Namely, according to the present technology, the core of the wires of the steel cord is made from carbon steel with a carbon content of from 0.60 mass % to 0.75 mass %, so it is possible to increase the productivity of the steel cord. On the one hand, the strength of the steel cord is from 3000 MPa to 3500 MPa based on severe plastic deformation, so it is possible to provide a strength equal to or greater than that of conventionally used steel cord made from carbon steel with a carbon content exceeding 0.75 mass %. Moreover, the average thickness of the plating layer of the wires of the steel cord is from 0.23 μm to 0.33 μm, so even if severe plastic deformation is carried out, the formation of pinholes in the plating layer is avoided, so it is possible to prevent reduction in the adhesion of the steel cord. As a result, even when steel cord made from carbon steel with a carbon content of not more than 0.75 mass % having excellent productivity is used, it is possible to provide a pneumatic tire having durability performance equal to or greater than the durability performance when steel cord made from carbon steel with a carbon content exceeding 0.75 mass % is used.

In the present technology, preferably, a rubber penetration rate of the steel cord is not less than 75%. In this way, even if pinholes are formed in the plating layer of the wire of the steel cord based on the severe plastic deformation and the ferrous substrate of the core is exposed, adhesion of the steel cord is sufficiently ensured, and it is possible to improve the durability performance of the pneumatic tire. Here, preferably, the lateral cross-sectional shape of the steel cord is oblate in shape, and, the steel cord has a 1×N structure. Steel cord with these structures is advantageous for achieving the above-described rubber penetration rate.

There is no particular limitation on the reinforcing layer to which the above-described steel cord is applied, but preferably the above-described steel cord is applied to a belt layer, a carcass layer, or a side reinforcing layer of a pneumatic tire. In particular, if the above-described steel cord is applied to a belt layer, preferably, a belt cover layer is wound around the outer periphery of the belt layer so as to cover at least an edge portion of the belt layer. In this way, it is possible to effectively prevent edge separation of the belt layer.

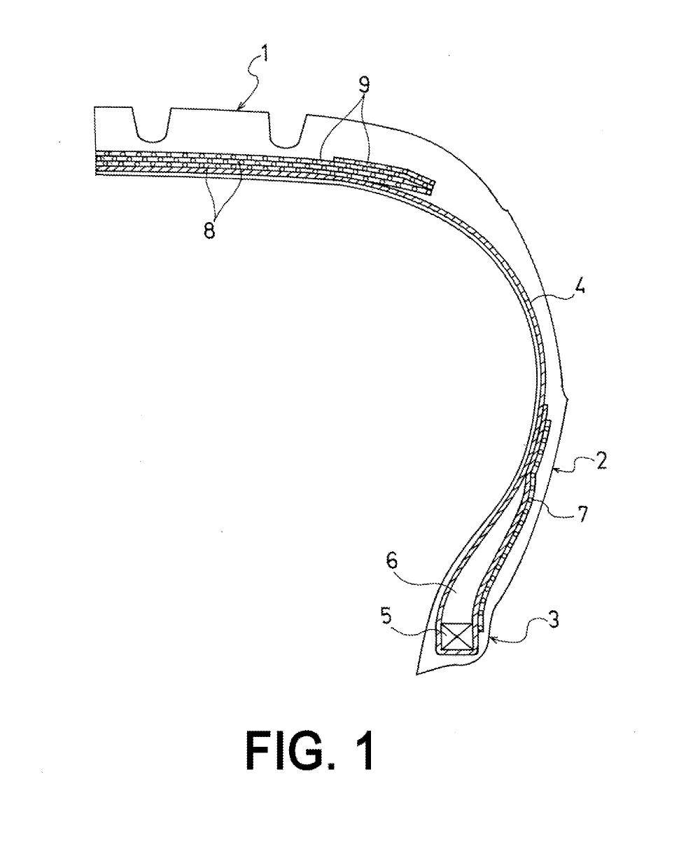

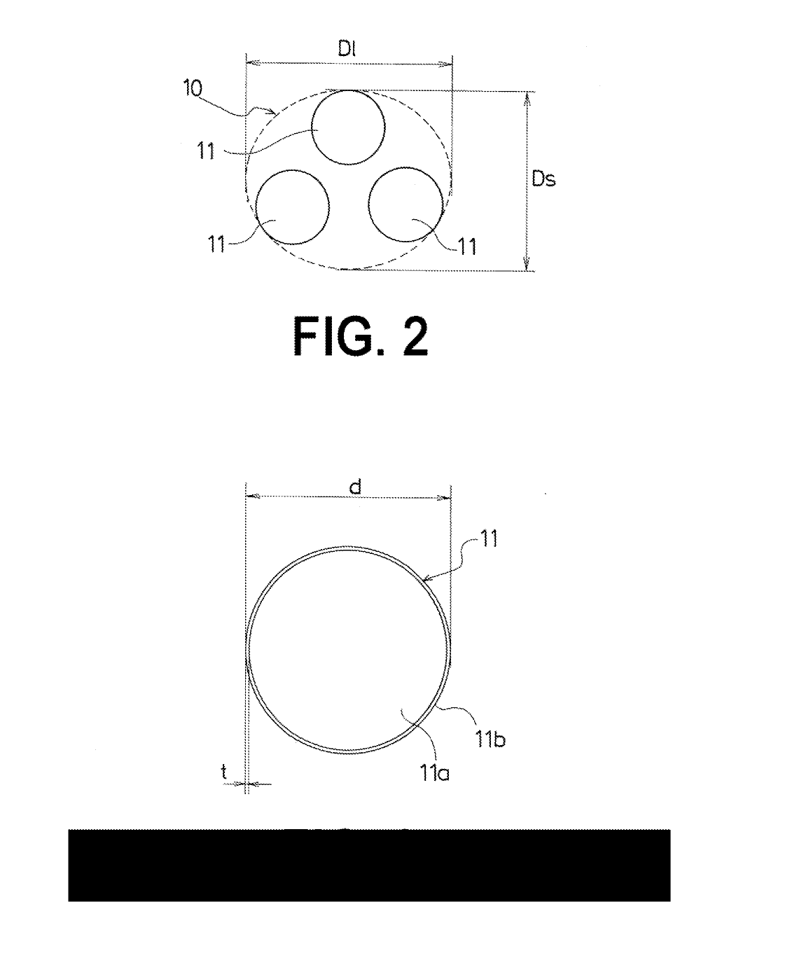

Detailed descriptions will be given below of a configuration of the present technology with reference to the accompanying drawings. FIG. 1 illustrates a pneumatic tire according to an embodiment of the present technology, and FIG. 2 and FIG. 3 illustrate the steel cord and the wire respectively used in the reinforcing layer of the present technology.

In FIG. 1, 1 is a tread portion; 2 is a side wall portion; and 3 is a bead portion. A carcass layer 4 is mounted between the left-right pair of bead portions 3,3. The carcass layer 4 includes a plurality of reinforcing cords extending in a tire radial direction, and is folded back around a bead core 5 disposed in each of the bead portions 3 from a tire inner side to a tire outer side.

A bead filler 6 is disposed on a periphery of the bead core 5, and the bead filler 6 is enveloped by a main body part and the folded over part of the carcass layer 4. Also, a side reinforcing layer 7 that includes a plurality of reinforcing cords laid in parallel is embedded from the bead portion 3 to the side wall portion 2 throughout the whole circumference of the tire. In the side reinforcing layer 7, an inclination angle of the reinforcing cords with respect to the tire circumferential direction is set in a range from, for example, 10° to 60°. The inclination angle of the reinforcing cords of the side reinforcing layer 7 can be set as appropriate in accordance with the required steering stability, and by increasing the inclination angle, the steering stability can be increased.

On the other hand, a plurality of layers of a belt layer 8 is embedded on an outer circumferential side of the carcass layer 4 in the tread portion 1. These belt layers 8 include a plurality of reinforcing cords that incline with respect to the tire circumferential direction, and the reinforcing cords are disposed between the layers so as to intersect each other. In the belt layers 8, an inclination angle of the reinforcing cords with respect to the tire circumferential direction is set in a range from, for example, 10° to 40°.

For the purpose of enhancing high-speed durability, at least one layer of a belt cover layer 9 formed by arranging reinforcing cords at an angle of not more than 5° with respect to the tire circumferential direction, is disposed on an outer circumferential side of the belt layers 8. The belt cover layer 9 preferably has a jointless structure in which a strip material made from at least a single reinforcing cord laid in parallel and covered with rubber is wound continuously in the tire circumferential direction. Nylon or similar organic fiber cords are preferably used as the reinforcing cords of the belt cover layer 9.

In the pneumatic tire as described above, a steel cord 10 (see FIG. 2 and FIG. 3) having the following configuration is used as the reinforcing cord from which at least one of the carcass layer 4, the side reinforcing layer 7, and the belt layers 8 (preferably, the belt layer 8) is configured. Namely, the steel cord 10 has a structure in which a plurality of wires 11 is twisted together, and the wire diameter d is set in the range of from 0.15 mm to 0.40 mm. Each of the wires 11 is configured from a core 11a and a plating layer 11b formed on the periphery of the core 11a. The core 11a is made from carbon steel with a carbon content of from 0.60 mass % to 0.75 mass %. Also, the average thickness t of the plating layer 11b is set in the range of from 0.23 μm to 0.33 μm. In addition, the strength of the steel cord 10 when embedded in the tire is set in the range of from 3000 MPa to 3500 MPa.

The steel cord 10 as described above can be manufactured by the following method. Namely, the raw material is piano wire with a diameter in the range of from 5.5 mm to 6.5 mm made from carbon steel having a carbon content within the above-described range. After this wire has been first subjected to wire drawing process to an intermediate wire diameter of about 2.0 mm, a brass plating process is performed on this intermediate drawn wire material. Next, the intermediate drawn wire material that has been plated with brass is subjected to the wire drawing process so that a final wire drawing process strain is not less than 3.8, and more preferably 3.8 to 4.5, to form the wire 11 with a wire diameter d within the above-described range. Then, by twisting together a plurality of the wires 11 that have been subjected to the wire drawing process as appropriate, the steel cord 10 can be obtained with a strength in the above-described range.

The final wire drawing process strain (R) represents the amount of wire drawing process from the plated wire to the final product, and is given by R=2×ln(d0/d1), where the diameter of the plated wire is d0, and the diameter of the final product is d1.

In the pneumatic tire provided with the reinforcing layer in which a plurality of steel cords 10 are laid in parallel and embedded in the rubber as described above, the core 11a of the wires 11 of the steel cord 10 is made from carbon steel with a carbon content of from 0.60 mass % to 0.75 mass %, so it is possible to increase the productivity of the steel cords 10. In particular, the production efficiency until the intermediate drawn wire material that has been subjected to the plating process is dramatically improved, so it is possible to reduce the manufacturing cost of the steel cords 10. Here, if the carbon content of the core 11a is less than 0.60 mass %, the steel cords 10 will be soft and the fatigue resistance will be poor. Conversely, if the carbon content of the core 11a exceeds 0.75 mass %, the steel cords 10 become hard, so low velocity processing is necessary and the productivity is reduced.

Also, the strength of the steel cords 10 is from 3000 MPa to 3500 MPa based on severe plastic deformation, so it is possible to provide a strength equal to or greater than that of conventionally used steel cords made from carbon steel with a carbon content exceeding 0.75 mass %. Here, if the strength of the steel cords 10 is less than 3000 MPa, the durability performance of the pneumatic tire is reduced due to the reduction in strength of the reinforcing layer that includes the steel cords 10. Conversely, if the strength of the steel cords 10 exceeds 3500 MPa, the wires 11 can easily break due to a reduction in the toughness of the steel material, so the durability performance of the pneumatic tire is reduced.

In addition, the average thickness t of the plating layer 11b of the wires 11 of the steel cord 10 is from 0.23 μm to 0.33 μm, so even if severe plastic deformation is carried out, the formation of pinholes in the plating layer 11b is avoided, so it is possible to prevent reduction in the adhesion of the steel cords 10. Here, if the average thickness t of the plating layer 11b is less than 0.23 μm, pinholes are formed in the plating layer 11b, so the ferrous substrate of the core 11a is easily exposed, and the adhesion of the steel cords 10 is reduced. Conversely, if the average thickness t of the plating layer 11b exceeds 0.33 μm, the adhesion of the steel cords 10 is reduced due to brittleness of the plating layer 11b. In particular, if the wire diameter d is 0.32 mm or less, preferably, the average thickness t of the plating layer 11b is within the range of from 0.23 μm to 0.30 μm, and if the wire diameter d exceeds 0.32 mm, preferably the average thickness t of the plating layer 11b is within the range of from 0.27 μm to 0.33 μm.

The average thickness t of the plating layer 11b can be measured as follows. First, a test specimen of the wire 11 that has been weighed in advance is immersed in a liquid containing 25 mL of 12% hydrochloric acid to which 0.15 mL of 34% hydrogen peroxide has been added, and the plating layer 11b on the surface is selectively dissolved. Next, the solution is heated over a water bath to decompose the excess hydrogen peroxide. After cooling, the solution is transferred to a measuring flask and distilled water is added up to 100 mL. Then, the test liquid is transferred to a test tube (approximately 20 mL), and analyzed using an ICP analysis instrument (Shimadzu ICPS-8000). Also, standard Cu solution (manufactured by Kanto Chemical Co., Inc.), standard Zn solution (manufactured by Kanto Chemical Co., Inc.), 12% hydrochloric acid, and Y203 solution (Kanto Chemical Co., Inc.) are blended and a calibration line produced, and the mass of Cu (g/kg) and Zn (g/kg) in the plating layer 11 per 1 kg of wire is measured. The average thickness t is calculated from the general formula obtained taking into consideration the specific gravity of iron and brass and the cross-sectional area of the wire, namely, average thickness t (μm)=[Cu mass (g/kg)+Zn mass (g/kg)]×wire diameter d (mm)×0.235.

As described above, it is possible to provide a pneumatic tire having durability performance equal to or greater than the durability performance when steel cord made from carbon steel with a carbon content exceeding 0.75 mass % is used, even when steel cords 10 made from carbon steel with a carbon content of 0.75 mass % having excellent productivity is used, by configuring the core 11a of the wires 11 of the steel cord 10 from carbon steel having a carbon content of from 0.60 mass % to 0.75 mass %, increasing the strength of the steel cord 10 based on severe plastic deformation, and increasing the average thickness t of the plating layer 11b.

In the pneumatic tire as described above, the rubber penetration rate of the steel cord 10 is preferably 75% or greater. In this way, even if pinholes are formed in the plating layer 11b of the wires 11 of the steel cord 10 based on the severe plastic deformation and the ferrous substrate of the core 11a is exposed, sufficient adhesion of the steel cords 10 is ensured, and it is possible to improve the durability performance of the pneumatic tire.

The rubber penetration rate of the steel cord 10 can be measured as follows. First, the steel cord 10 is extracted from the pneumatic tire, and the rubber adhering to the outside of the cord is removed with a cutter knife or the like. Next, one wire 11 is removed from the steel cord 10, and the percentage of the area into which the rubber has penetrated into the interior of the steel cord 10 is measured. This measurement may be carried out visually, but preferably the percentage of the area into which the rubber has penetrated is found based on image data. This measurement is made at 8 locations along the circumference of the tire, and the average value of the rubber penetration rate measured at the 8 locations is taken to be the rubber penetration rate of the steel cords 10.

In order to achieve the above rubber penetration rate, preferably, the steel cord 10 is oblate in shape in the lateral cross-section of the steel cord 10. In FIG. 2, the steel cord 10 has an oblate shape defined by a long diameter D1 and a short diameter Ds. The ratio of the long diameter D1 to the short diameter Ds (D1/Ds) may be in the range of from 1.2 to 1.6. By making the steel cord 10 in an oblate shape in this way, rubber can easily penetrate into the interior of the cord.

Also, in order to achieve the above-described rubber penetration rate, preferably, the steel cord 10 has a 1×N structure (N=2 to 6) in which N wires 11 are twisted together in a bundle as illustrated in FIG. 2. In this way, rubber can easily penetrate into the interior of the cord. A 1×N structure is the most preferable twisted structure, but beside that structure, for example, an m+n structure having a core made from m wires and a sheath made from n wires (m=1 to 2, n=2 to 6) may be adopted. In this case, it is possible to ensure the rubber penetration rate by reducing the number of wires of the sheath to less than the number at the maximum density. In each of these twisted structures, it is possible to adopt an open structure in which a gap is provided between wires by carrying out a reforming process on the wires.

In addition, in order to achieve the above-described rubber penetration rate, rubber that is flexible in the unvulcanized state may be adopted as the coating rubber for covering the steel cord 10. In this way, rubber can easily penetrate into the interior of the cord.

In the embodiment as described above, the steel cord 10 having a specific structure is applied to the carcass layer 4, the side reinforcing layer 7, or the belt layers 8, but in particular, if the above-described steel cord 10 is applied to the belt layers 8, preferably, the belt cover layer 9 is wound around the outer periphery side of the belt layers 8 so as to cover at least the edge portion of the belt layers 8. In this way, it is possible to effectively prevent edge separation of the belt layers 8, and obtain the advantages of the low cost steel cords 10 to maximum extent.

In the pneumatic tire as described above, for the portions where the steel cords 10 having the specific structure are not applied as the reinforcing cord of the carcass layer 4, the side reinforcing layer 7, and the belt layers 8, reinforcing cords that are normally used in the tire industry can be used. For example, other steel cords or organic fiber cords such as nylon or polyester can be used as these reinforcing cords.

The above was a detailed description of a preferred embodiment of the present technology, but it should be understood that various changes, substitutions, and replacements can be made to this embodiment, provided that they do not deviate from the spirit and scope of the present technology as specified in the attached scope of claims.

### EXAMPLES

Pneumatic tires of size 195/65R15 having a belt layer in which a plurality of steel cords were laid in parallel and embedded in rubber were produced as Conventional Example 1, Working Examples 1 and 2, and Comparative Examples 1 to 4. The steel cords of the belt layers were configured from a plurality of wires twisted together, and each wire was configured from a core and a plating layer formed on the periphery of the core. The carbon content (mass %) of the core, the final wire drawing process strain, the average thickness (μm) of the plating layer, the wire diameter (mm), the cord structure, the cord diameter (mm), the cord breaking force (N) and the cord strength (MPa) were set as shown in Table 1.

These test tires were evaluated for steel cord rubber penetration rate and tire durability performance by the evaluation methods described below, and the results are also shown in Table 1.

### Rubber Penetration Rate

A steel cord was extracted from the belt layer of the test tires, the rubber adhering to the outside of the cord was removed with a cutter knife or the like, one wire was removed from the steel cord, and the percentage of the area where the rubber had penetrated into the interior of the steel cord was measured based on image data. This measurement was made at 8 locations along the circumference of the tire, and the average value of the rubber penetration rate measured at the 8 locations was taken to be the rubber penetration rate of the steel cords.

### Tire Durability Performance

Each test fire was degraded for 30 days under conditions of a temperature of 70° C. and a humidity of 95%, after which, each test tire was fitted to a wheel with rim size of 15×6JJ with the air pressure set to 200 kPa, a driving test was started using an indoor drum tester under the conditions of load 5 kN and velocity 121 km/h, each 30 minutes the velocity was increased by 8 km/h, and the distance driven until the test tires failed was measured. Evaluation results were expressed as index values, Conventional Example 1 being assigned an index value of 100. The higher the index value, the better the tire durability performance.

TABLE 1

| | | | Conventional | Working | Working |
|---|---|---|---|---|---|
| | | | Example 1 | Example 1 | Example 2 |
| Wire | Carbon content of core (%) | | 0.82 | 0.72 | 0.62 |
| | Final wire drawing process | | 3.5 | 3.8 | 4.2 |
| | strain | | | | |
| | Average thickness of | | 0.22 | 0.24 | 0.32 |
| | plating layer (μm) | | | | |
| | Wire diameter (mm) | | 0.28 | 0.28 | 0.28 |
| Steel | Cord structure | | 1 × 3 | 1 × 3 | 1 × 3 |
| cord | Cord diameter | Long | 0.79 | 0.79 | 0.83 |
| | (mm) | diameter | | | |
| | | Short | 0.61 | 0.61 | 0.61 |
| | | diameter | | | |

| | | | |
|---|---|---|---|
| Cord breaking force (N) | 600 | 605 | 600 |
| Cord strength (MPa) | 3248 | 3275 | 3248 |
| Rubber penetration rate (%) | 70 | 70 | 85 |

| | | | |
|---|---|---|---|
| Tire durability performance (index) | 100 | 100 | 102 |

| | | | Comparative | Comparative | Comparative | Comparative |
|---|---|---|---|---|---|---|
| | | | Example 1 | Example 2 | Example 3 | Example 4 |
| Wire | Carbon content of | | 0.72 | 0.72 | 0.72 | 0.72 |
| | core (%) | | | | | |
| | Final wire drawing | | 3.8 | 3.8 | 3.5 | 4.4 |
| | process strain | | | | | |
| | Average thickness | | 0.22 | 0.35 | 0.24 | 0.24 |
| | of plating layer | | | | | |
| | (μm) | | | | | |
| | Wire diameter (mm) | | 0.28 | 0.28 | 0.28 | 0.28 |
| Steel | Cord structure | | 1 × 3 | 1 × 3 | 1 × 3 | 1 × 3 |
| cord | Cord | Long | 0.79 | 0.79 | 0.79 | 0.79 |
| | diameter | diameter | | | | |
| | (mm) | Short | 0.61 | 0.61 | 0.61 | 0.61 |
| | | diameter | | | | |

| | | | | |
|---|---|---|---|---|
| Cord breaking | 600 | 600 | 550 | 670 |
| force (N) | | | | |
| Cord strength (MPa) | 3248 | 3248 | 2977 | 3627 |
| Rubber penetration | 70 | 70 | 70 | 70 |
| rate (%) | | | | |

| | | | | |
|---|---|---|---|---|
| Tire durability | 98 | 97 | 99 | 96 |
| performance (index) | | | | |

As can be seen from Table 1, the tires according to Working Examples 1 and 2 exhibited durability performance equal to or greater than that of Conventional Example 1 which used steel cords made from carbon steel with a carbon content exceeding 0.75 mass %, even though Working Examples 1 and 2 used steel cords with a carbon content of not more than 0.75 mass % with excellent productivity.

On the other hand, the tire according to Comparative Example 1 had an average thickness of the plating layer that was too thin, so the adhesion of the steel cords was reduced, and the tire durability performance was reduced. The tire according to comparative example 2 had an average thickness of the plating layer that was too thick, so the adhesion of the steel cords was reduced due to the brittleness of the plating layer, and the tire durability performance was reduced. The tire according to Comparative Example 3 had a strength of the steel cords that was too low, so the strength of the belt layer that included the steel cords was reduced, and the tire durability performance was reduced. The tire according to Comparative Example 4 had a strength of the steel cords that was too high, so the wires could easily break because the toughness of the carbon steel material was reduced, and the tire durability performance was reduced.

Next, tires were produced as Conventional Example 2, Working Examples 3 and 4, and Comparative Examples 5 to 8, having the same structure as Conventional Example 1, Working Examples 1 and 2, and Comparative Examples 1 to 4 except that the wire diameter of the wires of the steel cords was changed.

These test tires were evaluated for steel cord rubber penetration rate and tire durability performance by the evaluation methods described above, and the results are shown in Table 2.

TABLE 2

| | | | Conventional | Working | Working |
|---|---|---|---|---|---|
| | | | Example 2 | Example 3 | Example 4 |
| Wire | Carbon content of core (%) | | 0.82 | 0.72 | 0.62 |
| | Final wire drawing process | | 3.5 | 3.8 | 4.2 |
| | strain | | | | |
| | Average thickness of | | 0.22 | 0.24 | 0.32 |
| | plating layer (μm) | | | | |
| | Wire diameter (mm) | | 0.34 | 0.34 | 0.34 |
| Steel | Cord structure | | 1 × 3 | 1 × 3 | 1 × 3 |
| cord | Cord diameter | Long | 0.96 | 0.96 | 1.01 |
| | (mm) | diameter | | | |
| | | Short | 0.74 | 0.74 | 0.74 |
| | | diameter | | | |

| | | | |
|---|---|---|---|
| Cord breaking force (N) | 885 | 892 | 885 |
| Cord strength (MPa) | 3248 | 3275 | 3248 |
| Rubber penetration rate (%) | 70 | 70 | 85 |

| | | | |
|---|---|---|---|
| Tire durability performance (index) | 100 | 100 | 102 |

| | | | Comparative | Comparative | Comparative | Comparative |
|---|---|---|---|---|---|---|
| | | | Example 5 | Example 6 | Example 7 | Example 8 |
| Wire | Carbon content of | | 0.72 | 0.72 | 0.72 | 0.72 |
| | core (%) | | | | | |
| | Final wire drawing | | 3.8 | 3.8 | 3.5 | 4.4 |
| | process strain | | | | | |
| | Average thickness | | 0.22 | 0.35 | 0.24 | 0.24 |
| | of plating layer | | | | | |
| | (μm) | | | | | |
| | Wire diameter (mm) | | 0.34 | 0.34 | 0.34 | 0.34 |
| Steel | Cord structure | | 1 × 3 | 1 × 3 | 1 × 3 | 1 × 3 |
| cord | Cord | Long | 0.96 | 0.96 | 0.96 | 0.96 |
| | diameter | diameter | | | | |
| | (mm) | Short | 0.74 | 0.74 | 0.74 | 0.74 |
| | | diameter | | | | |

| | | | | |
|---|---|---|---|---|
| Cord breaking | 885 | 885 | 811 | 988 |
| force (N) | | | | |
| Cord strength (MPa) | 3248 | 3248 | 2977 | 3627 |
| Rubber penetration | 70 | 70 | 70 | 70 |
| rate (%) | | | | |

| | | | | |
|---|---|---|---|---|
| Tire durability | 98 | 97 | 99 | 96 |
| performance (index) | | | | |

As can be seen from Table 2, the tires according to Working Examples 3 and 4 exhibited durability performance equal to or greater than that of Conventional Example 2 which used steel cords made from carbon steel with a carbon content exceeding 0.75 mass %, even though Working Examples 3 and 4 used steel cords with a carbon content of not more than 0.75 mass % with excellent productivity.

On the other hand, Comparative Examples 5 to 8 showed the same tendencies as Comparative Examples 1 to 4, and in all cases, the tire durability performance was reduced compared with Conventional Example 2.

1. A pneumatic tire comprising a reinforcing layer formed from a plurality of steel cords being laid in parallel and embedded in rubber, each of the steel cords being configured from a plurality of wires twisted together, a wire diameter of each of the wires being from 0.15 mm to 0.40 mm, each of the wires comprising a core and a plating layer formed on the periphery of the core, the core being made from carbon steel with a carbon content of from 0.60 mass % to 0.75 mass %, an average thickness of the plating layer being from 0.23 μm to 0.33 μm, and a strength of the steel cord being from 3,000 MPa to 3,500 MPa.

2. The pneumatic tire according to claim 1, wherein a rubber penetration rate of the steel cord is not less than 75%.

3. The pneumatic tire according to claim 1, wherein a lateral cross-sectional shape of the steel cord is oblate in shape.

4. The pneumatic tire according to claim 3, wherein the steel cord has a 1×N structure.

5. The pneumatic tire according to claim 4, wherein the reinforcing layer is a belt layer, a carcass layer, or a side reinforcing layer.

6. The pneumatic tire according to claim 4, wherein the reinforcing layer is a belt layer, and a belt cover layer is wound around an outer periphery side of the belt layer so as to cover at least an edge portion of the belt layer.

7. The pneumatic tire according to claim 3, wherein the reinforcing layer is a belt layer, a carcass layer, or a side reinforcing layer.

8. The pneumatic tire according to claim 3, wherein the reinforcing layer is a belt layer, and a belt cover layer is wound around an outer periphery side of the belt layer so as to cover at least an edge portion of the belt layer.

9. The pneumatic tire according to claim 2, wherein the steel cord has a 1×N structure.

10. The pneumatic tire according to claim 2, wherein the reinforcing layer is a belt layer, a carcass layer, or a side reinforcing layer.

11. The pneumatic tire according to claim 2, wherein the reinforcing layer is a belt layer, and a belt cover layer is wound around an outer periphery side of the belt layer so as to cover at least an edge portion of the belt layer.

12. The pneumatic tire according to claim 1, wherein a lateral cross-sectional shape of the steel cord is oblate in shape.

13. The pneumatic tire according to claim 1, wherein the steel cord has a 1×N structure.

14. The pneumatic tire according to claim 1, wherein the reinforcing layer is a belt layer, a carcass layer, or a side reinforcing layer.

15. The pneumatic tire according to claim 1, wherein the reinforcing layer is a belt layer, and a belt cover layer is wound around an outer periphery side of the belt layer so as to cover at least an edge portion of the belt layer.
